(19) United States
(12) Patent Application Publication
(10) Pub. No.: US 2002/0085707 A1
(43) Pub. Date: Jul. 4, 2002

(54) Control of echo return loss on a PC based IP telephone

(76) Inventor: Robert B. Turnbull, Calgary (CA)

Correspondence Address: Garlick & Harrison, P.O. Box 670007, Dallas, TX, 75367, US

(21) Appl. No.: 09/751,467

(22) Filed: Dec. 29, 2000

(51) Int. Cl. H04M 9/08

(52) U.S. Cl. 379/406.07

(57) ABSTRACT

An audio interface couples a telephone handset to a computer over a Universal Serial Bus and detects/attenuates echo return loss in the voice signals going through the interface. The computer is coupled to a packet switched network, such as the Internet or some other WAN. The audio interface includes a codec for generating 8-bit μ-law signals from analog voice signals and vice versa. A microprocessor converts the μ-law signals to 16-bit linear signals and monitors these signals for signs of speech. If receive speech is detected, the transmit path is attenuated. If transmit speech is detected, the receive path is attenuated. If both transmit and receive speech is detected, the receive path is partially attenuated.

### BACKGROUND OF THE INVENTION

I. Field of the Invention

The present invention relates generally to IP-based telephony. Particularly, the present invention relates to controlling echo return loss in an IP-based telephone.

II. Description of the Related Art

Echo, in a telephone system, is noticeable when one party on a call (near end) hears their own voice echoing back with a slight delay. Echo, as experienced by the near end, is unintentionally introduced at the far end by some form of coupling between the transmit and receive paths. This commonly occurs electrically or acoustically.

Acoustic coupling occurs when some of the sound from the earphone is picked up by the microphone. This may occur acoustically through the air or mechanically through the vibrations of the physical structure of the handset or headset.

Electrical coupling may occur as crosstalk in the wiring or associated electronics of the telephone. Electrical coupling may occur even through a telephone headset.

Any audio coupling between receive and transmit at the far end will be perceptible at the near end as an echo any time there is an appreciable round trip delay in the telephone network. It is generally accepted that a round trip delay of greater than 50 ms will result in noticeable far end echo.

Even though echo exists in present technology, it has not been noticeable due to the round trip delay in telephone networks being quite short so that the echo is masked by the near end user's own voice. The echo may also be unnoticeable since it is mixed with a deliberately introduced side tone.

Overseas calls, due to the distances involved, experience substantial delay. In this case, elaborate echo cancellers are incorporated into the telephone network to remove far end echo.

The present trend is to replace traditional Time Division Multiplexed (TDM)-based telephone networks with packet switched, Internet Protocol (IP) networks such as Corporate local area networks (LANs), wide area networks (WANs), and the Internet. While IP networks offer many advantages over TDM networks, the IP networks experience their own problems.

The nature of the packet delivery mechanism introduces substantial delay. Delay in a packet-based network comes from the fundamental packet size. The data is in a packet so delay is equal to at least one packet worth of data. Additionally, packet arrival time cannot be guaranteed so a reservoir of packets must be kept in order to cover time when packets arrive late. In this case, additional delay is equal to the depth of the jitter buffer.

The above delays must be doubled to realize the round trip delay. Typically, in IP telephony, a round trip delay may exceed 200 ms. This is a delay that is noticeable to the users.

It is obvious that the two requirements for perceptible echo are present in an IP telephony system. These are a source of coupling at the far end and round trip delay.

While delay can be minimized, a certain amount of delay is unavoidable in IP telephony. Therefore, to avoid echo in IP telephony systems, it is the responsibility of each endpoint to ensure that they do not introduce echo or, if they do, to have a means to effectively remove it.

Normally, echo removal is handled by the well-known technique of echo cancellation. This is a computation intensive process and typically takes place in a digital signal processor (DSP)—a specialized processor that is optimized for signal processing techniques.

Echo control algorithms must operate in real-time with respect to the point where the echo is introduced. Since the echo is introduced at the transducers, the echo is best controlled directly at the transducers.

The introduction of IP networks as a vehicle for telephony allows the personal computer to actually become a telephone since the PC is already IP aware. Many software telephones have been developed but the PC hardware and operating system do not lend themselves to quality telephony for many reasons.

PC's do not have controllable audio systems. Users are allowed and typically expected to source their own audio cards and transducers. These devices vary in characteristics between manufacturers and even models within on manufacturer.

Additionally, the PC operating system is not real time so it does not lend itself well to the type of computations required for echo canceling. There is a resulting unforeseen need for a way to control echo return loss in an IP telephony system, thereby providing improved audio quality communication.

### SUMMARY OF THE INVENTION

The present invention encompasses an apparatus for control of echo return loss in a communication system. The communication system is coupled to a packet switched network and comprises a telephone device that has a plurality of transducers that include a speaker and a microphone. A computer runs a communication program.

The apparatus comprises a converter coupled to the telephone device. The converter generates analog signals from digital signals and converts digital signals into analog signals. In the preferred embodiment, the converter is a codec that generates a digital μ-law signal from an analog voice signal and also converts a received μ-law signal into an analog voice signal for use by the telephone device's speaker.

A bus interface couples the apparatus to the computer. The preferred embodiment uses a Universal Serial Bus interface.

A controller is coupled to the converter and the bus interface. In the preferred embodiment, the controller is a microprocessor that controls the operation of the apparatus by detecting and attenuating echo conditions.

### BRIEF DESCRIPTION OF THE DRAWINGS

FIG. 1 shows an IP telephony system in accordance with the present invention.

FIG. 2 shows the audio interface of the present invention incorporated into an IP telephony system.

FIG. 3 shows a block diagram of the audio interface of the present invention.

FIG. 4 shows a flow diagram of the echo return loss control process of the present invention.

### DETAILED DESCRIPTION OF THE PREFERRED EMBODIMENT

The echo return loss control process and apparatus of the present invention provides improved audio in an IP telephony system. By coupling an external audio interface, comprising an echo control process, to a personal computer, the control that is required for high quality telephony is now present in the IP telephony system.

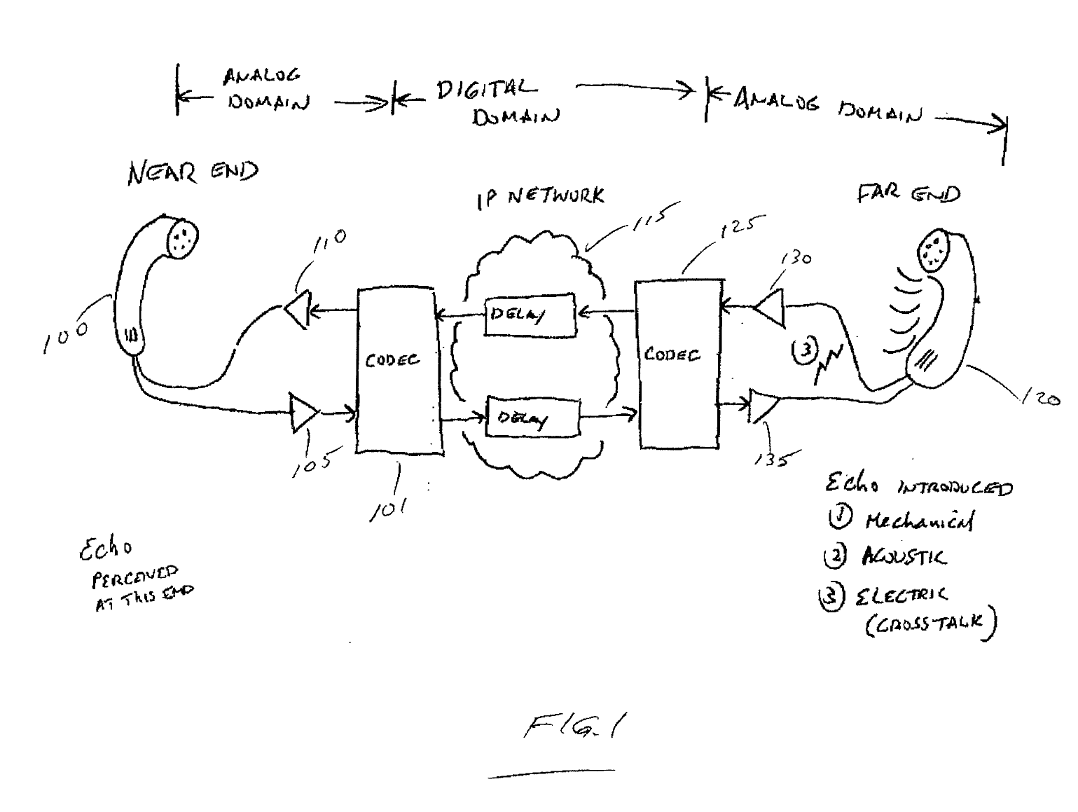

An IP telephony system is illustrated in FIG. 1. This system is comprised of a near end telephone (100) that is coupled to a codec (101). The codec (101) is a coder/decoder for converting an analog speech signal into a digital signal for transmission over the IP network (115). The codec (101) also converts a digital signal from the IP network (115) into an analog speech signal for radiation by the transducer in the telephone (100). Codecs are well known in the art and are not discussed further here.

The speech signal from the telephone (100) is coupled to the codec (101) through an amplifier (105). Similarly, the speech signal from the codec is coupled to the telephone (100) through another amplifier (110).

Similarly, the far end telephone (120) is coupled to a codec (125) through amplifiers (130 and 135). The codec (125) is then coupled to the IP network (115).

The echo is introduced on the far end telephone (120) by the methods described above. The delay of the IP network (115) then makes the echo more apparent to the near end user.

The discussion of the present invention references a telephone handset as the means by which the communication is accomplished over the IP network. However, a telephone handset is only one embodiment for use in the IP telephony network. Any communication device incorporating the transducers, either mounted together in the same unit or separately, is encompassed by the present invention. A telephone headset that incorporates a speaker and microphone is one such embodiment.

The IP network of the present invention encompasses many different packet networks. One embodiment uses the Internet to transmit the telephone conversation. Other embodiments use LANs, WANs, and other packet-type networks.

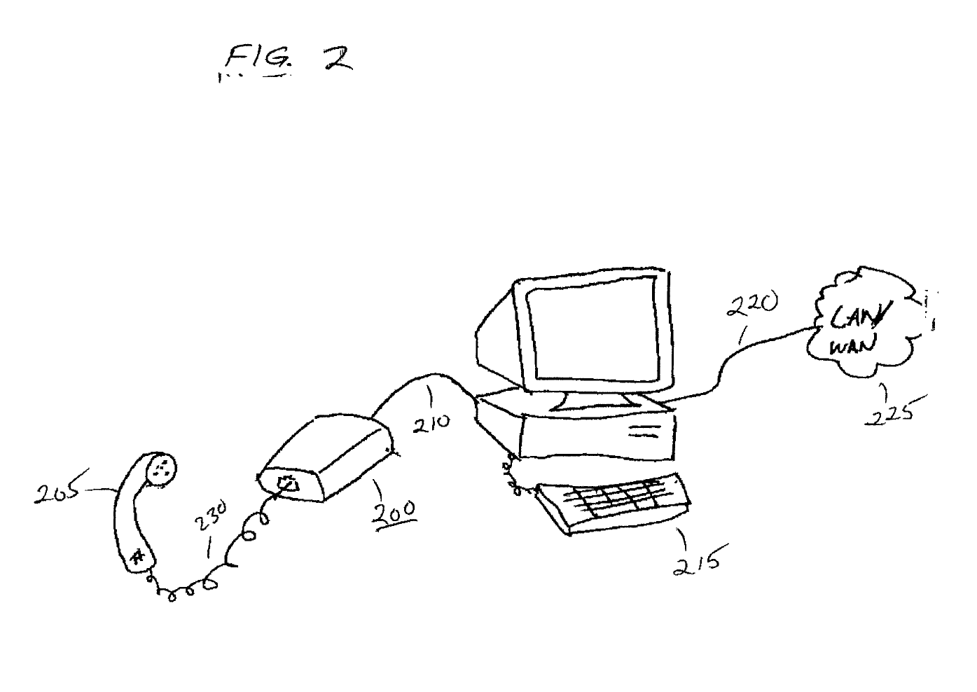

FIG. 2 illustrates the IP telephony system incorporating the external audio interface (200) of the present invention. The system is comprised of the external audio interface (200) that couples the telephony handset (205) to the PC (215).

The telephony handset (205) is comprised of the transducers required for communication. In the preferred embodiment, the handset (205) transducers comprise a speaker and a microphone. The telephony handset (205) is coupled to the audio interface (200) by a handset cord (230).

The handset cord (230) is comprised of a line that couples the speaker to the audio interface (200) and another line that couples the microphone to the audio interface (200). Alternate embodiments use other types and quantities of connections to the audio interface (200) depending on the type of handset used.

In the preferred embodiment, the audio interface (200) is coupled to the PC (215) through a Universal Serial Bus (USB) cable (210). The USB cable (210) is coupled to the USB port of the PC (215). USB cables and USB ports are well known in the art and are not discussed further.

Alternate embodiments use other forms of connections to the PC (215). One embodiment uses the PC's communication port. Another embodiment uses a direction connection to the PC's bus. The present invention encompasses any type of connection that provides sufficient bandwidth for the audio interface to operate properly between the handset and the PC.

The PC (215) is a typical computer that runs an operating system such as WINDOWS or MACINTOSH. For example, the PC (215) may be an HP PAVILLION 6466 running WINDOWS 98. One embodiment uses a desktop-type computer while another embodiment uses a laptop or other type of portable computer. The present invention encompasses any computer to which the audio interface (200) can be coupled using the preferred embodiment USB cable or other types of connections as described above.

The PC (215) is responsible for running the telephony software required for communication over the IP network (225). There are multiple communication applications on the market that enable the PC to operate as a telephone. These telephone applications are subsequently referred to as softphone processes.

The PC (215) is coupled to the IP network (225) over a LAN connection (220). The LAN connection (220) is any connection of adequate bandwidth depending on the type of network (225) to which the PC is coupled and the connection requirements for that particular network (225).

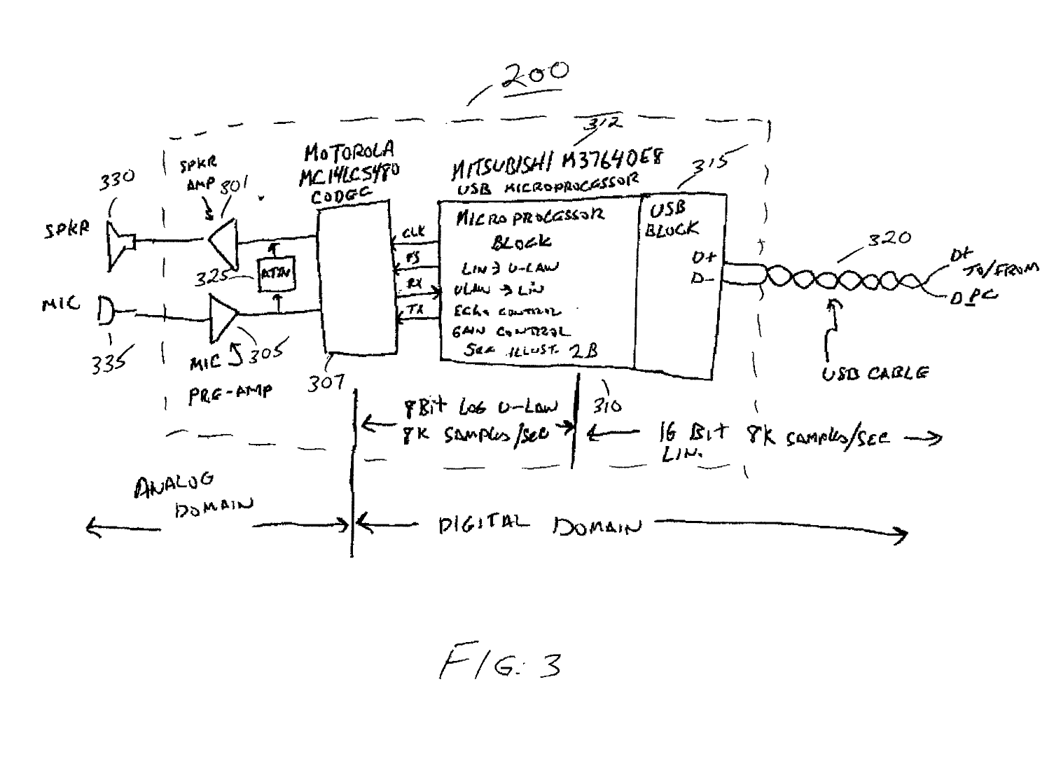

A block diagram of the audio interface (200) of the present invention is illustrated in FIG. 3. The audio interface (200) is comprised of a speaker amplifier (301) that couples the output of the audio interface (200) to the speaker (330) of the telephone handset. The speaker amplifier (301) increases the power output of the audio interface (200) in order to drive the speaker at normal volume. In one embodiment, this amplifier (301) is biased to have an adjustable gain that allows the user to vary the volume of the output of the audio interface (200).

A microphone amplifier (305) couples the microphone (335) of the telephone handset to the audio interface (200). This amplifier (305) increases the voice signal's amplitude from the microphone (335) to a level that is useful to the codec (307).

Both the speaker amplifier and the microphone amplifier, in the preferred embodiment, are standard op-amps. Alternate embodiments use other forms of amplifiers to perform substantially the same function.

The codec (307) is a standard 8-bit μ-law coder/decoder that digitizes an analog input signal from the microphone amplifier (305) to produce a digital representation of the voice signal from the user. The codec (307) also converts the digital signal from the digital domain of the system into an analog voice signal for transmission to the speaker amplifier (301).

In the preferred embodiment, the codec (307) is a MOTOROLA MC14LC5480 integrated circuit. Alternate embodiments use other manufacturers' codecs or even other ways to perform the digital to analog and analog to digital conversions. For example, DAC and ADC integrated circuits are available to perform these processes in place of the coded.

The codec (307) is coupled to the microprocessor (312) through an Rx line to the microprocessor (312), a Tx line from the microprocessor (312), a clock line from the microprocessor (312), and an FS line from the microprocessor (312).

The Rx line transmits the digital representations of the voice signals from the user's telephone handset. The Tx line transmits the digital signals from the far end to the codec (307) for conversion to analog signals and subsequent transmission to the speaker of the telephone handset.

The clock line provides the conversion clock required by the analog-to-digital and digital-to-analog processes of the codec. Various clock frequencies may be used. An alternate embodiment uses a separate oscillator to generate the clock required by the codec.

A microprocessor (312) controls the operation of the audio interface (200). In the preferred embodiment, the microprocessor (312) is an 8-bit USB microprocessor manufactured by MITSUBISHI having a model number M37640E8. This microprocessor is comprised of a microprocessor block (310) and a USB block (315).

The microprocessor block (310) is responsible for running the echo return loss control processes of the present invention that are discussed subsequently with relation to operation of the present invention. The USB block (315) is responsible for taking the signals from the

Alternate embodiments use other types of microprocessors and other microprocessor manufacturers. For example, one embodiment uses a separate microprocessor and USB controller that are coupled together.

The USB block (315) of the microprocessor (312) is coupled to the PC, in the preferred embodiment, through a USB cable (320). The USB cable (320) carries the control signals, digital Rx audio, digital Tx audio, and power for the audio interface. The USB cable configuration is well known in the art and is not discussed further.

The operation of the audio interface is discussed with reference to FIG. 3. Audio is streamed to and from the audio interface (200) of the present invention over the USB connection (320). The audio is in a digital format that is represented by 16-bit linear coding and 8 k samples/second. This is one of the standard WAVE formats commonly used in PCs. The WAVE interface is part of the WINDOWS OS and is not described further.

The PC presents a standard WAVE audio interface for the softphone process. Audio data received from the softphone process at the WAVE interface is passed to the PC USB port by standard WINDOWS programming techniques.

The audio arrives at the audio interface's USB port. The 16-bit linear data is received from the USB block (315) in the microprocessor (312). The microprocessor block (310) performs a conversion on the 16-bit data to generate 8-bit μ-law logarithmic coding.

The 8-bit μ-law data is passed from the microprocessor (312) to the 8-bit μ-law codec (307). The codec (307) converts the data to a linear form. It is then amplified by the amplifier (301) to drive the transducer (330) (speaker or earphone).

On the transmit side of the audio interface (200), low level analog signals from the microphone (335) are amplified (305) and fed to the codec (307). The codec (307) converts these signals to 8-bit μ-law format and passes them to the microprocessor (312).

The microprocessor block (310) converts this data to 16-bit linear and passes it to the USB block (315) of the microprocessor (312) for transmission. The USB block (315) transmits the data over the USB cable (320) to the PC where it appears as a standard WAVE audio interface for the softphone application.

An artificial sidetone path (325) is provided to simulate the sidetone experienced on analog telephone connections. Without the sidetone, the near end user will hear only silence in the speaker giving the impression that the connection has been lost. This path (325) provides a small portion of the transmit audio mixed directly with the receive audio.

The effect of the sidetone is that the user hears their own voice and the room ambient sound at a low level in the receive path. This sidetone path (325) exists directly in the analog domain at the transducer amplifiers. The sidetone path (325) does not contribute to echo since it couples to the receive path and not the transmit path.

As discussed above, echo is introduced acoustically and mechanically in the handset/headset or electrically in the handset/headset cord or electronics (in the analog domain). It is manifest in the form of a portion of the receive audio being coupled into the transmit path. Therefore, it is necessary to remove as much receive audio from the transmit path as possible.

Rather than relying on the usual echo cancellation techniques, the present invention takes a much simpler approach. A linear representation of both the transmit and the receive audio exists in the 8-bit microprocessor as it passes it back and forth between the USB block and the codec. This data represents the transmit and receive audio in real time with respect to the source of coupling. The microprocessor, therefore, has the ability to measure and affect the amplitude of these signals as they pass through it. This makes it possible for the microprocessor to make a determination that the receive path is speaking and, therefore, insert attenuation into the transmit path. This has the effect of adding attenuation to the echo path, thus removing the source of the echo.

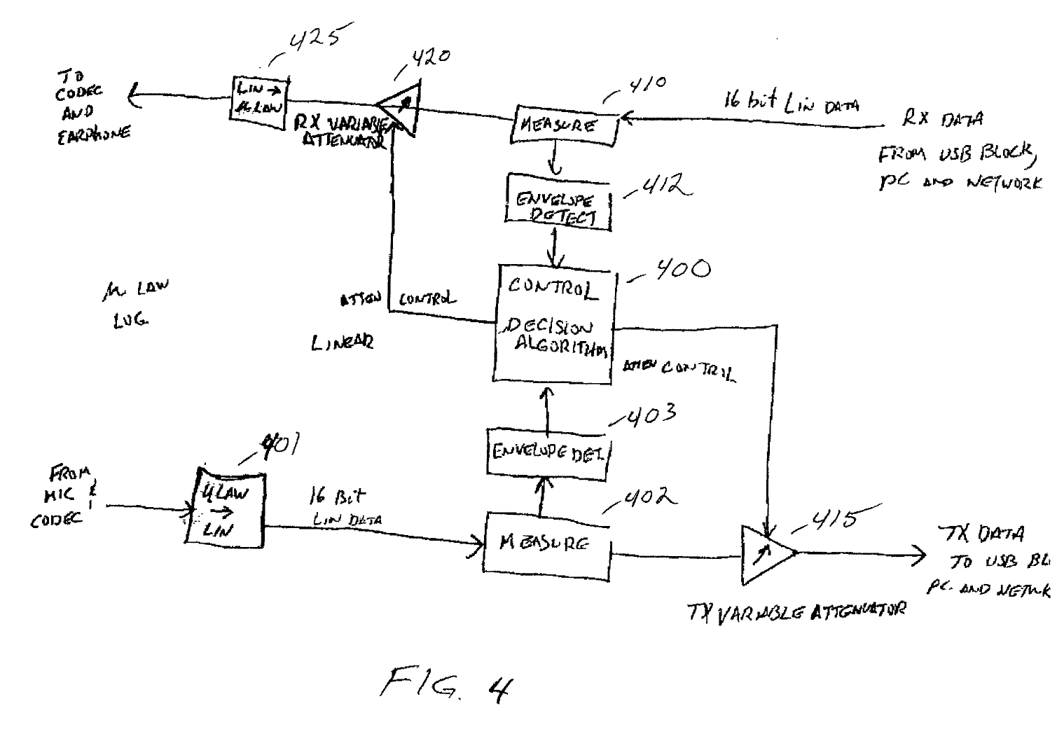

If the depth of the attenuation is selected correctly, it will be possible to remove the source of the echo from the transmit path to an extent that the softphone application will meet the requirements of TIA 810 for echo control. TIA 810 is a standard for IP telephone communication and is well known in the art. The determination of talker direction and depth of attenuation takes place in the control/decision process discussed subsequently with relation to FIG. 4. The basic idea of this process is to keep 10 to 20 dB of attenuation in the echo path during the time that there is some speech activity in the Rx direction.

FIG. 4 illustrates the echo return loss control process of the present invention. The digital audio from the codec is transformed into 16-bit linear data in the μ-law to linear converter block (401). This data is input to the measure block (402) where it is sampled at the 8 k samples/second rate. The measured samples are then passed through the envelope detection block (403) where they are averaged over time to produce a representation of the speech, also referred to as the speech envelope.

The speech envelopes have a fast attack time and a slower decay time. Envelope samples are produced at the rate of 250 samples/second and passed to the control/decision block (400).

The data from the measure block (402) is input to a Tx variable attenuator (415) that is controlled by the control/decision block (400). The output of the Tx variable attenuator goes to the USB block and then to the PC and network as described previously.

The 16-bit linear Rx data from the network, PC, and USB block is input to the measure block (410). The measured samples are then passed through the envelope detection block (403) where they are averaged over time to produce a representation of the speech, also referred to as the speech envelope.

As in the Tx path, the speech envelopes have a fast attack time and a slower decay time. Envelope samples are produced at the rate of 250 samples/second and passed to the control/decision block (400).

The output of the measure block (410) is input to the Rx variable attenuator (420) that is controlled by the control/decision block (400). The output of the attenuator (420) is input to the linear to μ-law converter block (425) and then to the codec and speaker/earphone as described previously.

The control/decision block (400) looks at the relative amplitudes of both transmit and receive envelopes. The process keeps a switching threshold above which it determines that there is speech activity present. Based on the process's rules, it can insert attenuation (425 and 415) into either or both of the Rx or Tx variable attenuation stages.

The rules of the control/decision block are summarized as follows:

Rx Audio only=Full attenuation in Tx direction. No attenuation in Rx direction.

Tx Audio only=Full attenuation in Rx direction. No attenuation in Tx direction.

Rx & Tx Audio=Partial attenuation in Rx direction. No attenuation in Tx direction.

Full attenuation is to be determined to be sufficient to increase echo return loss (reduce echo) to below the amount specified in the requirements (e.g., TIA 810). Partial attenuation is any value that is less than full attenuation. Partial attenuation is used when the control process determines that both the near and far ends are speaking at the same time. In this case, less attenuation is required since the near end speech will mask the echo to a limited extent.

Alternate embodiments of the present invention include contentiously variable attenuation, adaptation of switching threshold based on near and far end computed noise floors and soft ramping of the attenuation values.

In summary, the audio interface of the present invention provides echo control without the use of expensive digital signal processors. This is accomplished by using an 8-bit microprocessor that runs a process that stops an echo from being introduced instead of canceling an echo that has already been generated.

1. An apparatus for control of echo return loss in a communication system using a packet switched network, the communication system comprising a telephone device having a plurality of transducers and a computer for running a communication process, the apparatus comprising:
a converter coupled to the telephone device, the converter generating analog signals from digital signals and digital signals from analog signals;
a bus interface coupled to the computer, the bus interface coupling the apparatus to the communication system; and
a controller coupled to the converter and the bus interface, the controller controlling operation of the apparatus by detecting and attenuating echo conditions.

2. The apparatus of claim 1 wherein the bus interface is a Universal Serial Bus interface.

3. The apparatus of claim 1 wherein the controller is a microprocessor that comprises means for detecting an input signal's relative amplitude and means for inserting attenuation in a transmit or receive signal in response to the amplitude.

4. The apparatus of claim 1 wherein the converter comprises a codec.

5. The apparatus of claim 1 wherein the telephone device comprises a telephone handset and the plurality of transducers comprise a microphone and a speaker.

6. The apparatus of claim 1 wherein the telephone device comprises a telephone headset and the plurality of transducers comprise a microphone and a speaker.

7. The apparatus of claim 1 and further including a side tone path coupled between an input and an output of the converter, the side tone path inserting a side tone in a signal from the output of the converter in response to an input signal.

8. A method for controlling echo return loss in a computer-based communication device coupled to a packet switched network, the method comprising the steps of:
detecting a receive linear signal from the communication device;
detecting a transmit linear signal from the communication device;
measuring a relative amplitude of the receive linear signal;
measuring a relative amplitude of the transmit linear signal;
if the relative amplitude of the receive linear signal is greater than a switching threshold, attenuating the transmit linear signal; and
if the relative amplitude of the transmit linear signal is greater than the switching threshold, attenuating the receive linear signal.

9. The method of claim 8 and further including the step of if the relative amplitudes of both the receive linear signal and the transmit linear signal are above the switching threshold, attenuating the receive linear signal.

10. The method of claim 8 wherein the step of attenuating the transmit linear signal includes full attenuation of the transmit linear signal.

11. The method of claim 8 wherein the step of attenuating the receive linear signal includes full attenuation of the receive linear signal.

12. The method of claim 9 wherein the step of attenuating the receive linear signal includes partial attenuation of the receive linear signal.

13. The method of claim 8 wherein the step of measuring a relative amplitude of the receive linear signal includes detecting an envelope of the receive linear signal.

14. The method of claim 8 wherein the step of measuring a relative amplitude of the transmit linear signal includes detecting an envelope of the transmit linear signal.

15. A communication system that communicates over a packet switched network, the communication system comprising:
a telephone device comprising a plurality of transducers;
an audio interface coupled to the telephone device, the audio interface comprising:
a codec coupled to the telephone device, the codec having means for converting transmit analog signals from the telephone device to transmit digital signals and the codec also having means for converting receive digital signals from the packet switched network to receive analog signals for use by the telephone device; and
a controller comprising a bus interface and a microprocessor for controlling the audio interface, the microprocessor having means for detecting an input signal's relative amplitude and controlling attenuation of the transmit and receive digital signals in response to the input signal's relative amplitude; and
a computer coupled to the bus interface and the packet switched network, the computer comprising a controller that runs a communication process.

16. A method for controlling echo return loss on a computer-based internet protocol communication apparatus, the communication apparatus comprising a telephone device that generates an analog voice signal, a codec, and a microprocessor, the communication apparatus receiving a receive digital linear signal from an internet protocol network, the method comprising the steps of:
the codec converting the analog voice signal to a transmit digital μ-law signal;
converting the transmit digital μ-law signal to a transmit digital linear signal;
sampling the transmit digital linear signal to generate transmit measured samples;
averaging the transmit measured samples over time to produce a transmit speech envelope;
sampling the receive digital linear signal to generate receive measured samples;
averaging the receive measured samples over time to produce a receive speech envelope;
if the receive speech envelope indicates receive speech is present, attenuating the transmit digital linear signal; and
if the transmit speech envelope indicates transmit speech is present, attenuating the receive digital linear signal.

17. The method of claim 16 and further including the step of if both the receive and transmit speech envelopes indicate speech in their respective signals, partially attenuating the receive digital linear signal.

18. The method of claim 16 and further including the steps of:
converting the receive digital linear signal to a receive digital μ-law signal; and
converting the receive digital μ-law signal to an analog signal for use by the telephone device.

19. An apparatus for control of echo return loss in a computer-based internet protocol communication system, the apparatus comprising:
means for converting a transmit digital μ-law signal to a transmit linear signal;
means for sampling the transmit linear signal to generate transmit measured samples;
means for averaging the transmit measured samples over time to generate a transmit speech envelope;
means for sampling a receive linear signal to generate receive measured samples; means for averaging the receive measured samples over time to generate a receive speech envelope;
means for comparing relative amplitudes of both the transmit speech envelope and the receive speech envelope;
means for inserting receive attenuation in the receive linear signal, coupled to the means for comparing, in response to detection of speech in the transmit speech envelope; and
means for inserting transmit attenuation in the transmit linear signal, coupled to the means for comparing, in response to detection of speech in the receive speech envelope.

20. The apparatus of claim 19 and further including means for converting the receive linear signal to a receive μ-law digital signal.

21. The apparatus of claim 20 and further including means for converting the receive μ-law digital signal to an analog signal for use by the communication system.
